(19) United States
(12) Patent Application Publication
(10) Pub. No.: US 2021/0129404 A1
(43) Pub. Date: May 6, 2021

(54) THIN WALL COMPOSITE PART MOLDING SYSTEMS AND METHODS

(71) Applicant: Stephen J. Eynon, Orion Township, MI (US)

(72) Inventor: Stephen J. Eynon, Orion Township, MI (US)

(21) Appl. No.: 17/082,203

(22) Filed: Oct. 28, 2020

Related U.S. Application Data
(60) Provisional application No. 62/930,017, filed on Nov. 4, 2019.

(51) Int. Cl. B29C 45/73; B29C 35/08; B29C 45/56; B29C 45/00

(52) U.S. Cl. CPC B29C 45/73; B29C 35/0805; B29C 2035/0811; B29C 45/0005; B29C 45/561

(57) ABSTRACT

A preheat assisted injection/compression molding system for producing thin wall, high fiber content, high flex modulus thermoplastic composites at high temperature includes a press, an injection mold operably coupled to the press and including a first mold portion having a first inner mold surface, and a second mold portion with a second inner mold surface, and a resin injection system configured to inject a molten, free flowing resin into the injection mold. A mold surface pre-heating system includes a heating element configured to selectively heat at least one of the first and second inner mold surfaces to a predetermined temperature at a predetermined depth before the resin is injected into the mold. A cooling system is configured to selectively cool at least one of the first and second inner mold surfaces to rapidly cool a molded part formed by compressing the resin with the press.

### CROSS REFERENCE TO RELATED APPLICATION

This application claims the benefit of U.S. Provisional Patent Application No. 62/930,017 filed Nov. 4, 2019, the contents of which are incorporated herein in their entirety by reference thereto.

### FIELD

The present application relates generally to forming vehicle structural components and, more particularly, to systems and methods to produce thin wall, high fiber content, high flex modulus, high temperature structural Class-A composite parts.

### BACKGROUND

Lightweight composite materials that require thin walls and a Class-A finish have not been able to be successfully injection molded over large areas. In some examples, thin, strong and rigid composites with performance similar to steel and aluminum formed via typical molding processes can potentially result in wavy surface profiles and/or knit lines. Additionally, reinforcing fiber alignment caused by resin flow can potentially result in molded-in stress and wavy surface profiles. While conventional methods of part forming do work well for their intended purpose, there remains a need for improvement in the relevant art.

### SUMMARY

In accordance with one example aspect of the invention, a preheat assisted injection/compression molding system for producing thin wall, high fiber content, high flex modulus thermoplastic composites at high temperature is provided. In one example implementation, the molding system includes a press, an injection mold operably coupled to the press and including a first mold portion having a first inner mold surface, and a second mold portion with a second inner mold surface, and a resin injection system configured to inject a molten, free flowing resin into the injection mold. A mold surface pre-heating system includes a heating element configured to selectively heat at least one of the first and second inner mold surfaces to a predetermined temperature at a predetermined depth before the resin is injected into the mold. A cooling system is configured to selectively cool at least one of the first and second inner mold surfaces to rapidly cool a molded part formed by compressing the resin with the press.

In addition to the foregoing, the describe molding system may include one or more of the following features: wherein the heating element is an internal induction coil disposed in the injection mold; wherein the heating element is an external induction coil selectively disposed between the first and second inner mold surfaces for heating thereof; wherein the heating element is a gas fired preheater selectively disposed between the first and second inner mold surfaces for heating thereof; and wherein the second inner mold surface defines a mold cavity to receive the molten, free flowing resin from the resin injection system.

In addition to the foregoing, the describe molding system may include one or more of the following features: wherein the predetermined temperature is greater than 120° C.; wherein the predetermined temperature is within a predetermined range of a melting point of the resin; where the predetermined range is within 50° C. of the melting point of the resin; wherein the predetermined range is within 15° C. of the melting point of the resin; wherein the melting point of the resin is between 510° F. and 705° F.; and wherein the predetermined depth is between approximately 1.0 mm and approximately 3.0 mm to facilitate latent heat required for molten free flow of the resin upon a mold final close.

In accordance with one example aspect of the invention, a method of producing thin wall, high fiber content, high flex modulus thermoplastic composites at high temperature with a preheat assisted injection/compression (PAIC) molding system having a press, an injection mold operably coupled to the press and including a first mold portion having a first inner mold surface, and a second mold portion with a second inner mold surface, a mold surface pre-heating system, and a cooling system is provided. In one example implementation, the method includes opening the injection mold, preheating at least one of the first and second inner mold surfaces to a predetermined temperature with the mold surface pre-heating system, partially closing the mold and injecting molten, free flowing resin into the injection mold, and closing the mold to on-stops condition to form an injection compression molded part.

In addition to the foregoing, the described method may include one or more of the following features: cooling the compression molded part with the cooling system; wherein the step of cooling the compression molded part comprises supplying high pressure coolant through the injection mold; wherein the step of heating at least one of the first and second inner mold surfaces comprises utilizing an induction heating coil to heat at least one of the first and second inner mold surfaces to a predetermined temperature; locating the induction coil into the injection mold for heating, and selectively removing the induction coil form the injection mold when at least one of the first and second inner mold surfaces reaches the predetermined temperature; and wherein the step of heating at least one of the first and second inner mold surfaces comprises utilizing a gas fired preheater to heat at least one of the first and second inner mold surfaces to a predetermined temperature.

Further areas of applicability of the teachings of the present application will become apparent from the detailed description, claims and the drawings. It should be understood that the detailed description, including disclosed embodiments and drawings referenced therein, are merely exemplary in nature intended for purposes of illustration only and are not intended to limit the scope of the present application, its application or uses. Thus, variations that do not depart from the gist of the present application are intended to be within the scope of the present application.

### BRIEF DESCRIPTION OF DRAWINGS

FIG. 1 is a schematic view of an example preheat assisted injection/compression molding system, in accordance with the principles of the present disclosure;

FIG. 2A is schematic plan view of a portion of the molding system shown in FIG. 1 with an external induction coil, in accordance with the principles of the present disclosure;

FIG. 2B is a schematic side view of the example external induction coil shown in FIG. 1, in accordance with the principles of the present disclosure;

FIG. 2C is a schematic illustration of an example gas fired preheater that may be utilized with the injection molding system shown in FIG. 1, in accordance with the principles of the present disclosure;

FIG. 3 is flow diagram of an example method of forming a composite part, in accordance with the principles of the present disclosure;

FIG. 4 is a flow diagram of another example method of forming a composite part, in accordance with the principles of the present disclosure; and

FIG. 5 is a flow diagram of yet another example method of forming a composite part, in accordance with the principles of the present disclosure.

### DESCRIPTION

According to the principles of the present application, systems and methods for producing thin wall, high fiber content, high flex modulus, high temperature structural class-A composite components are provided. In one example, the systems and methods utilize fast mold preheating, inject fiber reinforced thermoplastic composite into a partially open mold, and close on molten free flowing resin. The thin wall composite is then cooled to solidify the matrix with minimal pressures, fiber orientation, and cycle time. In some examples, the fast mold preheating includes a temperature of +/−25° F. or approximately +/−25° F. of the composite melt point.

In another example, injection mold composite material parts with thin cross-sections and a class-A finish are produced by performing the steps of preheating the mold, partially closing the mold, injecting resin into the partially closed mold, optionally evacuating air from the mold, closing the mold on the final fill, compressing the resin, pulse cooling the mold, and ejecting the finished part.

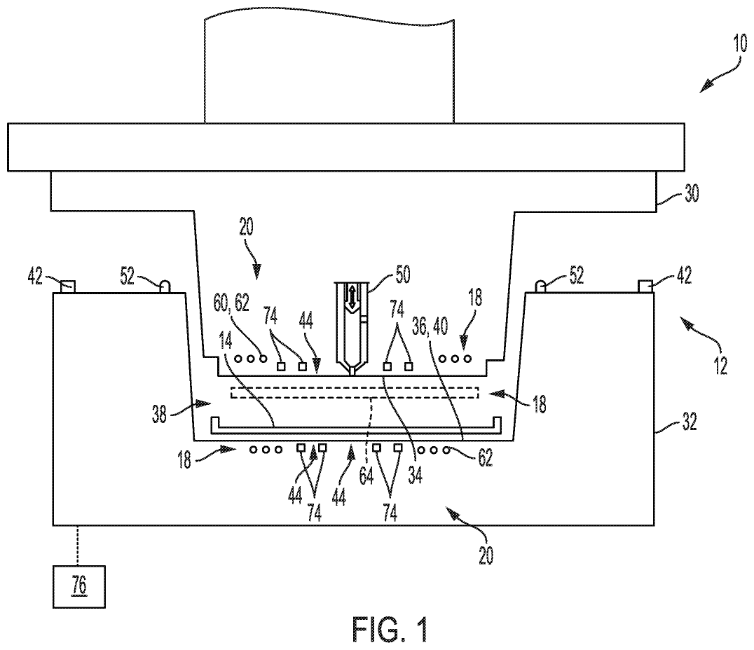

With reference now to FIG. 1, a schematic view of an example injection molding system 10 is illustrated. In the example embodiment, the injection molding system 10 generally includes an injection mold 12, a thermoplastic composite 14, a press 16, a mold surface pre-heating system 18, and a cooling system 20.

In the example embodiment, the injection mold 12 includes a core half or first mold portion 30 and a cavity half or second mold portion 32. The first mold portion 30 includes an inner molding surface 34, and the second mold portion 32 includes an inner molding surface 36 having a mold cavity 38 defined at least partially by a class-A finish show surface 40 corresponding to the molded part requirement. The inner surfaces 34, 36 and mold cavity 38 are configured to define the size and shape of the molded part. One or more stops 42 are configured to set a predetermined gap between the first and second molds 30, 32 to thereby set a desired part thickness (e.g., 1.5 mm). Additionally, at least one of the first mold portion 30 and the second mold portion 32 includes a magnetically permeable area 44 (e.g., proximate inner surfaces 34, 36) for quick induction heating of the first and second molds 30, 32, as described herein in more detail.

In some examples, the injection mold 12 includes an injection control system 50 (e.g., a valve gate) configured for selective position and/or time based metering of the volume of molten resin composite injected into the mold cavity 38. Additionally, in some configurations, a seal 52 is configured to seal around the mold cavity 38 between the first and second mold portions 30, 32 while off stops 42 to apply a vacuum if required or desired. It will be appreciated that injection mold 12 can include any suitable additional components to facilitate producing a composite part as described herein.

In one example embodiment, the thermoplastic fiber reinforced composite 14 includes enough carbon fiber content to enable the finished product to be electro-coated (e-coated) and paint compatible. Although base resins may vary, in one example, the composite 14 includes between approximately 7-40% carbon fiber and/or between approximately 0-33% glass fiber, or between 7-40% carbon fiber and/or between 0-33% glass fiber.

In another example, the composite 14 is semi-crystalline as molded with a melting point between approximately 310° C. and approximately 330° C., or between 310° C. and 330° C., a glass transition temperature (Tg) in a conditioned state between approximately 95° C. and approximately 150° C., or between 95° C. and 150° C., and a conditioned flex modulus between approximately 12 GPa and approximately 40 GPa, or between 12 GPa and 40 GPa. In yet another example, the composite 14 is semi-crystalline as molded with a melting point between approximately 215° C. and approximately 285° C., or between 215° C. and 285° C., a Tg in a conditioned state between approximately 75° C. and approximately 85° C., or between 75° C. and 85° C., and a conditioned flex or tensile modulus between approximately 8 GPa and approximately 14 GPa at 120° C., or between 8 GPa and 14 GPa at 120° C.

In yet another example, the composite 14 is amorphous as molded with a melting point between approximately 260° C. and approximately 340° C., or between 260° C. and 340° C., a Tg in a conditioned state between approximately 75° C. and approximately 85° C., or between 75° C. and 85° C., and a high flex modules between approximately 10 GPa and approximately 30 GPa at 120° C., or between 10 GPa and 30 GPa at 120° C. However, it will be appreciated that thermoplastic fiber reinforced composite 14 may include various carbon fiber contents, glass transition temperatures, melting points, and/or base resins to provide high flex modules composite matrices, and may be formulated for e-coating depending on part requirements.

In the example embodiment, the press 16 is operably coupled to the injection mold 12, pre-heating system 18, and injection control system 50 and is configured to heat, meter, and inject the fiber reinforced thermoplastic composite 14 into the preheated mold 12 before performing a compression injection operation to form the molded composite part 14. Additionally, press 16 is configured to remain open during the injection cycle, and close either partially or to on-stops position at any time during the injection cycle, as well as open and close the valve gate 50 that meters the fiber reinforced composite 14 into the mold 12 at any time during the injection or compression cycle. The press 16 is additionally configured to control the flow of or remove the cooling system coolant out of the mold 12 during the pre-heating portion of the molding cycle, and control flow into the mold 12 at any time during the injection, compression, or during the end of compression on-stops (full closed) cooling cycle. Additionally, the press 16 is configured to control the final mold close rate and apply a vacuum to the mold cavity 38, if required.

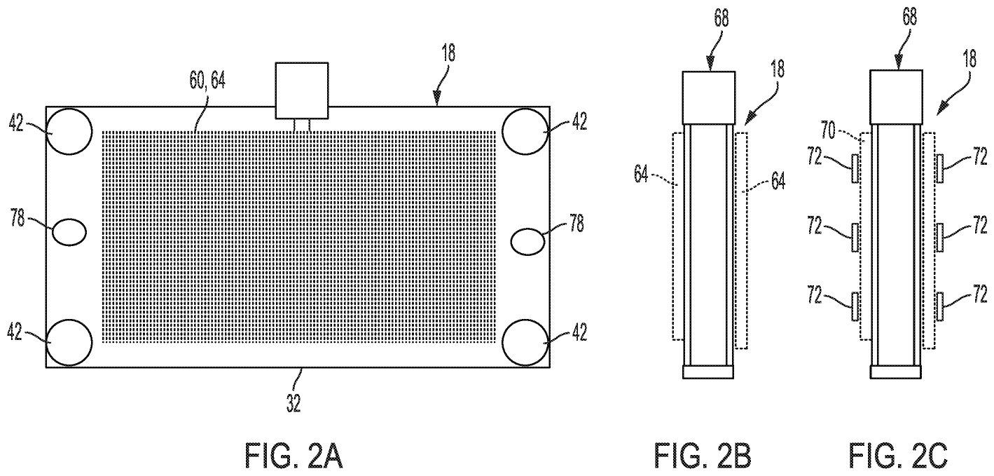

In the example embodiment, the mold surface pre-heating system 18 includes a heating element 60 such as, for example, an internal induction coil 62, an external induction coil 64, and/or a gas fired preheater 66 (e.g., hydrocarbon like natural gas, propane, etc.). FIG. 2A illustrates one example of internal induction coil 62 located within first and second molds 30, 32 (only one shown) on or beneath inner surfaces 34, 36. As shown in the example of FIG. 2B, external induction coil 64 is configured to be selectively positioned by a robotic arm 68 between inner surfaces 34, 36 in an open mold proximate the magnetically permeable area 44 (FIG. 1). In configurations utilizing the gas fired preheater 66, the preheater is robotically selectively positioned between and proximate the inner surfaces 34, 36 for heating thereof. As shown in the example of FIG. 2C, preheater 66 may be a tubular conduit 70 having a plurality of small burners 72 thereon.

As described herein, the pre-heating system 18 with heating element 60 is configured to perform various heating operations such as, for example: (i) preheating at least a portion of the mold inner surfaces 34, 36 to a predetermined temperature (e.g., between approximately 230° C. and approximately 345° C., or between 230° C. and 345° C.), (ii) limit a preheating zone depth to a predetermined depth into the mold halves 30, 32 from the inner surface 34, 36 (e.g., between approximately 1.0 mm and approximately 12 mm, or between 1.0 mm and 12 mm), (iii) control a surface temperature profile at injection across the mold 12 to a predetermined temperature (e.g., +/−approximately 25° F. or +/−25° F. of the resin melting point), and (iv) utilize high frequency close proximity induction coils 62, 64, and/or gas preheater 66 to limit heat affected depth to reduce time to cool.

In the example embodiment, cooling system 20 is configured to provide close proximity cooling of first and second mold portions 30, 32 of the mold to reduce mold surface temperature upon mold closing, to thereby quickly cool the part. In the example embodiment, the first and second molds 30, 32 each include a plurality passages 74 (FIG. 1) configured to direct a coolant therethrough such as, for example, high pressure water or oil. In one example, the cooling passages are located at a predetermined depth from mold surfaces 34, 36 of between approximately 6.0 mm and approximately 20 mm, or between 6.0 mm and 20 mm. In another example, the predetermined depth is between approximately 10 mm and approximately 12 mm, or between 10 mm and 12 mm.

In one example, the cooling system 20 operates at a predetermined pressure (e.g., 150-250 PSIG) and is configured to supply coolant at a first predetermined temperature (e.g., 350-400° F.) to begin cooling the part to reduce thermal shock. After a predetermined time (e.g., 2-5 seconds), the cooling system 20 is configured to subsequently provide coolant at a second, lower predetermined temperature (e.g., 260° F.) for rapid cooling of the molded part. However, it will be appreciated that cooling system 20 may have any suitable construction or operation that enables injection molding system 10 to function as described herein. Additionally, cooling system 20 can optionally include a high pressure and velocity cooling system capable of slowing or bypassing and evacuating the mold halves 30, 32 during the preheating cycle, for example, to reduce preheat loads and time to inject.

In the example embodiment, injection molding system 10 is configured to produce various vehicle components. For example, injection molding system 10 is configured to produce lightweight, large exterior surface area thin wall class-A body closures and panels such as doors, hoods, fenders, quarters, roofs, lift and swing gates, and vibration sensitive cameras and sensors used in safety and autonomous driving systems. Additional components include lightweight interior structural and/or class-A structural components such as, for example, integrated instrument panel cross members and carriers, load floors and load floor surrounds, and quarter and door trims, as well as lightweight under hood structural and/or class-A structural components such as, for example, turbocharger components (inlets, outlets, shrouds, conductive heat exchangers), and vibration sensitive sensors.

In some examples, the system 10 can produce components with a significant mass reduction compared to steel, aluminum, standard density SMC, and light-weight SMC for rigid body class-A panels. The system 10 is configured to reduce or eliminate showroom visual surface defects as compared to standard injection molding to produce a class-A rigid part. Warm mold injection-compression molding minimizes resin freeze off to the mold by injecting the composite while partially open into a warm cavity keeping the resin matrix molten (free flowing) until the mold is fully closed during the compression cycle, filling the cavity with low compression pressure. The sequence of injection of the composite into a partially open and warm mold followed by compression to complete mold fill reduces fiber orientation and breakage. The use of a warm mold surface (e.g., within 50° F. of the resin melt point) brings the resin into intimate contact with the mold surface (e.g., polished or textured) providing exceptional resin wetting of the mold surface. This yields superior fiber hiding and duplication of the mold finish on the molded part. For very large parts requiring long flow distances upon mold close, a vacuum may be applied to evacuate most of the atmosphere to reduce trapped gases upon fast mold final close, reducing cycle times further while enhancing the duplication of the mold surface finish in the molded part.

Injection mold system 10 is also configured reduce the number of injection sites inherent in class-A injection molding of large parts to facilitate no visible flow lines normally created by multiple injection sites and allowing for higher fiber reinforcing content. In some examples, only a single injection site is required in system 10. However, system 10 can include multiple injection sites, for example, where resultant flow lines can be masked by part features and well placed injection sites are metered to fill to that feature upon final compression. Such features are key benefits with the warm mold injection/compression molding that further widens the choices of composites and fiber loading up to a predetermined amount (e.g., 55% or approximately 55%) on a volumetric basis to increase the specific Flex Modulus resulting in tougher, thinner, and lighter rigid molded components and panels.

Further still, injection mold system 10 is configured to reduce in-molded stress, anisotropic physical properties, and differential shrink characteristics seen in standard injection molding by normalizing fiber distribution and random direction. This is done, for example, by injecting into a partially open mold and moving the matrix through a wider flow path along a warm contact surface during the compression step of the molding cycle. This wider and warmer flow path also decreases the molding pressures and normalizes pressure across the part upon final mold close as compared to standard injection molding at end of fill which are often as much as 80-90% lower than at the injection site for thin wall parts. Both attributes, more random fiber orientation and lower pressure gradient across the part, results in more consistent shrink across the part and less warp due to lower in-molded stress. In this way, this preheat assisted injection/compression (PAIC) mold system 10 is different from and provides the described advantages over conventional processes such as the Beetle Process (bulk molding compound injection/compression), thermoset SMC, glass mat thermoformable sheet, conventional hot oil/steam and pulse cool injection molding, and conventional sequentially valve gated (multi-injection site) injection molded.

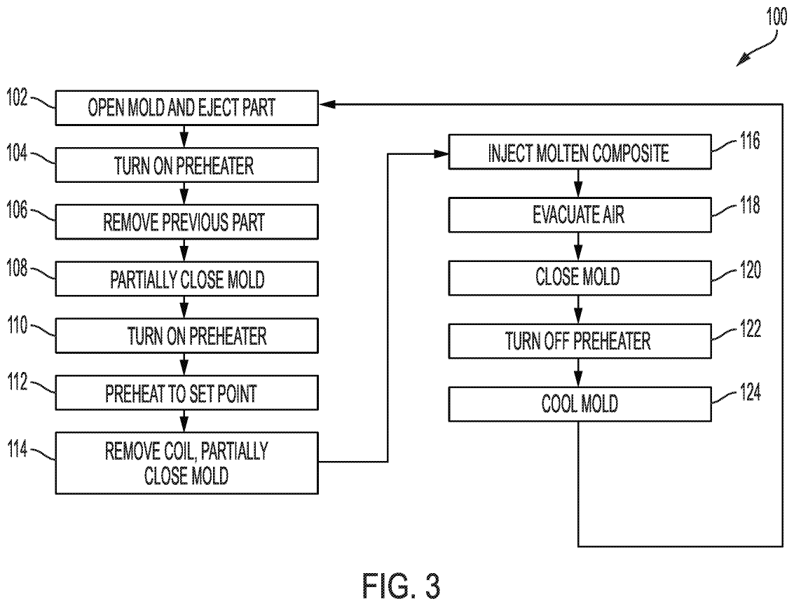

With reference now to FIG. 3, one example method 100 of operation of PAIC mold system 10 will be described in more detail. It will be appreciated that one or more of the steps or processes described herein can be performed by a controller 76 (FIG. 1). As used herein, the term controller refers to an application specific integrated circuit (ASIC), an electronic circuit, a processor (shared, dedicated, or group) and memory that executes one or more software or firmware programs, a combinational logic circuit, and/or other suitable components that provide the described functionality.

In the example process, the method begins at step 102 where the mold is opened and a formed part is ejected. Step 104 includes turning on the core and/or cavity mold surface proximity pre-heater system 18 if the internal coil 62 is used. At step 106, the class-A part from the previous cycle is removed. At step 108, the mold 12 is closed to a partially open mold position (e.g., approximately 0.5 cm to approximately 5.0 cm, or 0.5 cm to 5.0 cm) off stops if the internal coil 62 is used.

Step 110 includes placing and turning on the core and cavity mold surface proximity pre-heater system 18 if the external coil 64 is used. Step 112 includes continuing preheating of the core and cavity mold surfaces 34, 36 until the core half 30 and cavity half 32 reach a predetermined temperature (e.g., approximately −20° F. to approximately 50° F. or −20° F. to 50° F. of the resin melt point). However, in some examples the core mold surface 34 is heated slightly cooler than the resin melt point to stick the melt to the no-show side of the composite part 14 and avoid melt slumping due to gravity. Temperature of the core mold surface 34 may be adjusted by measuring the ejected part cavity and core temperature and reducing the core mold surface 34 preheat temperature until the temperature on both sides of the composite part 14 are approximately equal (e.g., 415° F. to 455° F.), or in some cases by increasing the cavity mold surface 36 temperature if reducing the core mold surface 34 temperature is difficult.

Step 114 includes removing the external coil 64 and closing the mold 12 to the partially open mold position if the external coil 64 is used. Step 116 includes injecting a predetermined amount (e.g., 50% to 100%) of molten composite resin matrix into the partially open mold from a non-show side or surface of the part/mold near the center of gravity for the part.

At step 118, air is evacuated from mold 12, for example, utilizing a vacuum assist, which is optionally utilized to reduce cycle time during compression step. In one example, after the compression cycle is started, a predetermined vacuum (e.g., 90%) is drawn to reduce cycle time and potential pre-gel of the composite part 14 to the core and cavity mold surfaces 34, 36. The melt is configured to displace air ahead of it upon injection and during initial compression. In some cases, vacuum assist reduces cycle time (e.g., 2-3 seconds) as you can close during the compression cycle quicker than without air evacuation.

At step 120, the mold 12 is completely closed to fill out mold/part. The mold 12 may be 100% filled in a partially open position, and compress to pack out while cooling under full close tonnage at an off stops condition upon close, or partially filled and then closed to an on stops position with the final fill and pack are done as the part is cooled via conventional injection molding during the pack and cooling cycles.

At step 122, the pre-heater system 18 is turned off during the final close or part fill cycle. Alternatively, the pre-heater system 18 may be turned off sooner than final resin matrix injection provided the mold 12 is closed fast enough to prevent pre-gel or freeze off of the resin matrix before the mold 12 is fully closed/filled out. Step 124 includes utilizing cooling system 20 to flood or pulse cooling both mold halves 30, 32 during the compression and/or injection cycle. During this operation, compression pressure is maintained as the part cools and an injection pack is added if desired. Control then returns to step 102.

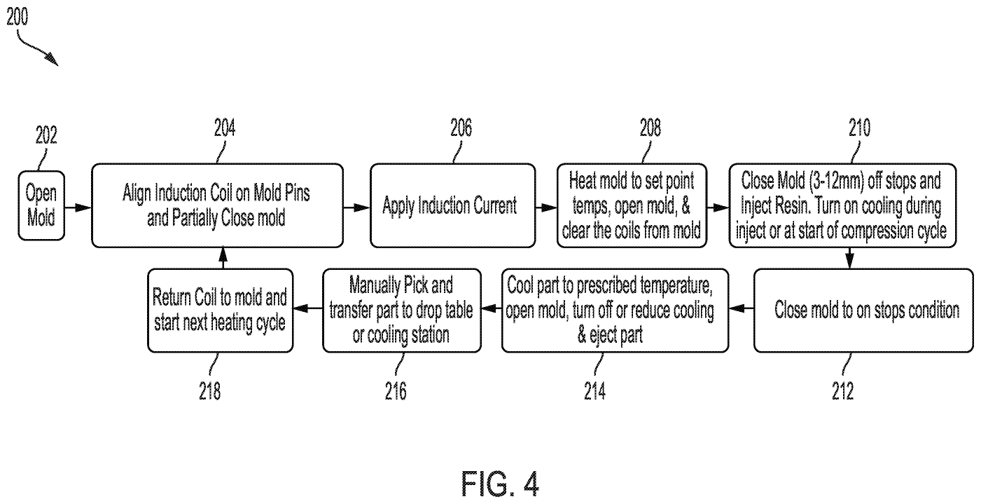

With reference now to FIG. 4, an example method 200 of operation of injection mold system 10 with external induction coil 64 will be described in more detail. In the example process, the method begins at step 202 and the mold 12 is opened. At step 204, pre-heating of the mold 12 is performed by aligning an external induction coil 64 (e.g., one induction coil for each of first and second molds 30, 32) on mold pins (not shown) through mold pin receivers 78 (FIG. 2A) and the mold 12 is partially closed to allow back and forth movement of the dual induction coil on the mold alignment pins receivers 78. At this point, the mold surface temperatures may be between 350-500° F. At step 206, induction current is applied to the external induction coil 64 (e.g., 100 to 150 KH). In this step, controller 76 may be utilized for a dual zone control (e.g., one zone in each of first and second mold portions 30, 32) or a predetermined number of zones (e.g., ten zones).

At step 208, the mold 12 is heated to a predetermined setpoint temperature (e.g., between 550-625° F.), opened, and the external induction coil 64 is removed from the mold 12. At step 210, mold 12 is partially closed to a predetermined distance (e.g., 3-12 mm) off the stops 42 and the resin is injected into the mold cavity 38. The cooling system 20 may be activated at this point or at the beginning of the following step. At step 212, mold 12 is closed to the on-stops condition. The resin injection may be terminated prior to this mold final close, during the final close, or a predetermined time after the final close (e.g., 2-10 seconds) depending on the material and mold temperature. At step 214, cooling system 20 continues operation and may include a second, cooler fluid input to further cool the molded part to the predetermined temperature (e.g., 350-500° F. depending on the resin system). The mold 12 is opened, and the cooling is either turned off or lowered to reduce heat transfer out of the mold, and the molded part is ejected. At step 216, the molded part is transferred to a cooling station (not shown). At step 218, the external induction coil 64 is returned to the mold 12 and the cycle is then repeated.

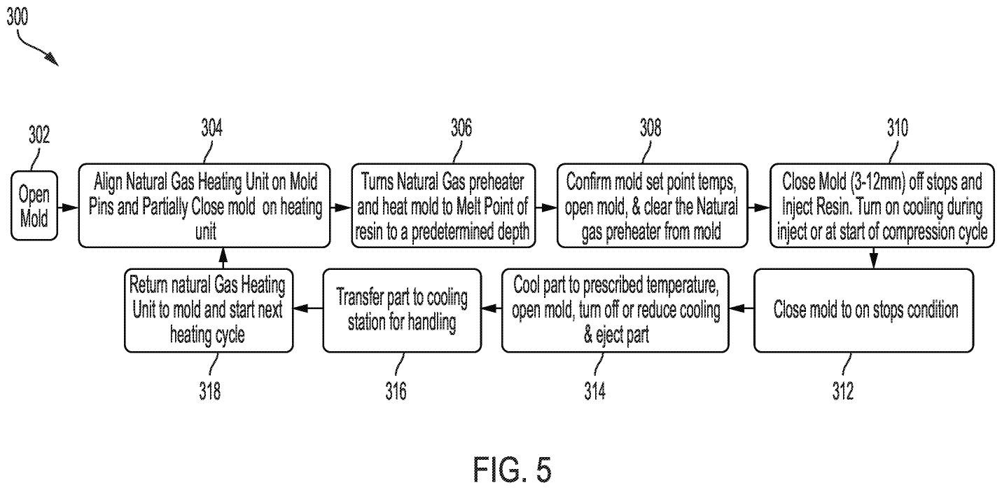

With reference now to FIG. 5, an example method 300 of operation of injection mold system 10 with gas fired preheater 66 will be described in more detail. In the example process, the method begins at step 302 and the mold 12 is opened. At step 304, pre-heating of the mold 12 is performed by robotically aligning gas preheater 66 on the mold pins with pin receivers 78 (FIG. 2A), and partially closing the mold 12 around the preheater 66. At this point, the mold surface temperatures may be between 350-500° F. At step 306, the gas preheater 66 is activated and heats the mold 12 to or slightly above the resin melt point (e.g., between 550-625° F.) on the Class-A side and at or slightly below the resin melt point on the no-show or core side to a predetermined depth (e.g., 1.0-2.0 mm), for example, using multizone burner closed loop control via controller 76. At step 308 the mold set point temperatures are confirmed reached (e.g., via temperature sensor in signal communication with controller 76), and the mold 12 is subsequently opened and the gas preheater 66 removed from the mold 12.

At step 310, mold 12 is partially closed to a predetermined distance (e.g., 3-12 mm) off the stops 42 and the resin is injected into the mold cavity 38. The cooling system 20 may be activated at this point or at the beginning of the following step. At step 312, mold 12 is closed to the on-stops condition. The resin injection may be terminated prior to this mold final close, during the final close, or a predetermined time after the final close (e.g., 2-10 seconds) depending on the material and mold temperature. At step 314, cooling system 20 is operated to cool the molded part to the predetermined temperature (e.g., 350-500° F. depending on the resin system), the mold 12 is opened, the cooling is either turned off or lowered, and the molded part is ejected. At step 316, the molded part is transferred to a cooling station (not shown). At step 318, the gas preheater 66 is returned to the mold 12 and the cycle is then repeated.

In one example operation, a molded part is produced with a 1.3-2.25 mm thickness at 0.25 mm off stops 42 via injection compression molding with induction preheat of both mold inner surfaces 34, 36 up to 700° F. and coolant up to 400° F. The thermoplastic fiber reinforced composite 14 is configured with a melt temperature of 550-705° F. or approximately 550° F. to approximately 705° F. with long and short fibers of up to 50% fiber content by volume. The injection mold 12 is configured to project 850 tons (1.5 tons/sq. inch). The external induction coil 64 is controlled to provide +/−15° F. across the mold inner surfaces 34, 36 and heat the mold surfaces 34, 36 and cavity 38 to a predetermined temperature (e.g., up 705° F. or approximately 705° F.) at a target depth (e.g., 2.0-3.0 mm) in a predetermined time (e.g., less than ten seconds).

Described herein are systems and methods for forming thin wall, high fiber content, high flex modulus, high temperature structural and/or class-A thermoplastic composite components or assemblies. The system utilizes fast mold heating, injects a fiber reinforced thermoplastic composite into a partially open mold, closes the mold on the molten free flowing resin, and subsequently cools the thin wall composite to solidify the matrix with minimal pressures, fiber orientation, and cycle time. Such systems enable normally wavy and rough conventionally injection molded surface composites to be molded with smooth (Class-A) surfaces. The system makes molding of components practical at less than sixty second cycle times, and enables the resin matrix to remain molten until the mold is closed in the compression cycle to reduce in-molded part stress and fiber directionality (the cause of part anisotropy and eddy flow surface waviness). Additionally, the system maintains the composite molten by keeping the mold near the resin matrix melt temperature during the entire mold fill through the end of the mold fill compression/pack process, reduces molding tonnage, cycle time, and cost, which lowers molding tonnage required to open up the part size envelope without major capex costs.

Conventional rigid panels are typically either stamped metals or sheet molding compound (SMC) thermosets. Such conventional rigid panels often require high rigidity over a wide temperature range that may reach 120° C., which requires 0.7 to 1.0 mm steel at 7.8 SpG, 1.1 to 1.25 mm aluminum at 2.7 SpG, or 2.3 to 2.7 mm thick thermosets at 1.27 to 1.93 SpG. Advantageously, the described system provides a significant mass reduction for rigid body Class-A panels compared to steel (e.g., 62%), aluminum (e.g., 23%), and standard density SMC thermosets (e.g., 53%).

Conventional Class-A thermoplastic panels have been historically confined to lower melt point thermoplastic resin systems (TPO, PPO, ABS, ASA, PA6, PA66, and PC/ABS). Such resins have glass transition temperatures (Tg) below 80° C. and are typically filled with talc or electroplated after molding to rigidize. Because operation temperatures are often above 80° C., these parts are primarily ornamental and vertical in body position.

Advantageously, in contrast, the systems described herein enable use of high strength and stiffness thermoplastic composites to make functional BIW components and assemblies with materials that typically achieve glass transition temperatures (Tg) greater than 120° C. with thermoplastics that are fiber reinforced instead of filled or post mold plated. Due to the high fiber content and high Tg, the finished molded parts have a lower shrink and coefficient of linear expansion, thereby making them more thermally stable to temperature changes unlike the conventional resin systems noted above, which do over-expand when heated to 120° C.

Additionally, the system allows preheating of the mold quickly and efficiently (e.g., via external induction coil 64) to minimize the part thickness required by high fiber reinforced grades of high Tg and high melt point resin systems to form the part at minimum molding pressures (e.g., lower press tonnage), as well as allows for wide discretion in process options regarding injection percent fill to start the compression cycle and still achieve a class-A part with good fiber distribution and integrity.

Moreover, the part and mold can be quickly cooled by placing the cooling lines closer to the mold surface (enabled by low molding pressures) to cool less of the mold and the thinner part at a higher temperature. The systems can create a total molding cycle time of 32 seconds (e.g., smaller ˜1.3 mm thick parts) to 56 seconds (e.g., larger ˜2.55 mm thick parts), thereby allowing for high volume production. The molding cycle and fiber orientation can be modified (e.g., higher percent fill at compression start results in more random fiber orientation). Additionally, the high melt and high Tg resin system described herein are robust for in-process scratch and marring damage after reaching Tg. Lower Tg resins do not have this inherent resiliency. As such, the described system results in lower post mold scrap and high post mold throughput.

Further, conventional straight injection cold mold or even elevated mold temp cycles cannot achieve Class-A surface quality for high flex modulus/high temp composites, since high fiber reinforced thermoplastics used to achieve the high flex modulus require high fiber loadings, which act as high density nucleation sites for crystalizing or freezing off thermoplastic composites when the resin matrix hits a colder than meltpoint mold surface. This nucleation reduces the time to flow the resin matrix during conventional injection molding, which creates in-molded stress and/or under pack surface defects. In contrast, with the process described herein, the composite remains molten against the mold, which is maintained at or above the resin matrix melt temperature and remains so during the entire mold fill through the end of the mold fill and compression/pack process on the Class-A side and near the meltpoint on the core side. This ensures a Class-A finish on a show side molded surface and greatly reduces in-molded stresses that can potentially result in more isotropic part behaviors.

Advantages of the described systems and methods over the prior Class-A thermoset options include: (i) utilizes recyclable thermoplastics as opposed to the prior Class-A thermosets, which are not readily recyclable, (ii) reduces or eliminates part flash, thus lowering dirt and paint rework, (iii) lowers or eliminates outgas from unreacted components from the reactive resin matrix of a thermoset during the painting process, (iv) lighter weight, and (v) increased stiffness at lower mass per unit volume with increased fiber content.

Accordingly, the systems described herein provide the ability to produce a PAIC molded part with a smooth Class-A surface as opposed to conventionally injection molded surface composites that are normally wavy and/or have rough surfaces. In most examples, the process and tooling make molding of high fiber reinforced Class-A panels and assemblies practical at less than 60 second cycle times. The described processing with combined injection compression molding and mold surface pre-heating at or slightly above the melt point of the resent matrix allows the matrix to remain molten until the mold is closed in the compression cycle. As such, the described systems and methods provide thin, lightweight composite materials to replace heavier materials typically used for large surface area interior and exterior vehicle components, reduce molded-in stress, enable class-A finish, enable stability at high temperatures, enable use of lower tonnage injection molding machines capable of off-stops injection followed by final close, to achieve short manufacturing cycle times and high repeatability on part mass and size.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

What is claimed is:

1. A preheat assisted injection/compression molding system for producing thin wall, high fiber content, high flex modulus thermoplastic composites at high temperature, the system comprising:
a press;
an injection mold operably coupled to the press and including a first mold portion having a first inner mold surface, and a second mold portion with a second inner mold surface;
a resin injection system configured to inject a molten, free flowing resin into the injection mold;
a mold surface pre-heating system including a heating element configured to selectively heat at least one of the first and second inner mold surfaces to a predetermined temperature at a predetermined depth before the resin is injected into the mold; and
a cooling system configured to selectively cool at least one of the first and second inner mold surfaces to rapidly cool a molded part formed by compressing the resin with the press.

2. The injection molding system of claim 1, wherein the heating element is an internal induction coil disposed in the injection mold.

3. The injection molding system of claim 1, wherein the heating element is an external induction coil selectively disposed between the first and second inner mold surfaces for heating thereof.

4. The injection molding system of claim 1, wherein the heating element is a gas fired preheater selectively disposed between the first and second inner mold surfaces for heating thereof.

5. The injection molding system of claim 1, wherein the second inner mold surface defines a mold cavity to receive the molten, free flowing resin from the resin injection system.

6. The injection molding system of claim 1, wherein the predetermined temperature is greater than 120° C.

7. The injection molding system of claim 1, wherein the predetermined temperature is within a predetermined range of a melting point of the resin.

8. The injection molding system of claim 7, where the predetermined range is within 50° C. of the melting point of the resin.

9. The injection molding system of claim 7, wherein the predetermined range is within 15° C. of the melting point of the resin.

10. The injection molding system of claim 7, wherein the melting point of the resin is between 510° F. and 705° F.

11. The injection molding system of claim 1, wherein the predetermined depth is between approximately 1.0 mm and approximately 3.0 mm to facilitate latent heat required for molten free flow of the resin upon a mold final close.

12. A method of producing thin wall, high fiber content, high flex modulus thermoplastic composites at high temperature with a preheat assisted injection/compression molding system having a press, an injection mold operably coupled to the press and including a first mold portion having a first inner mold surface, and a second mold portion with a second inner mold surface, a mold surface pre-heating system, and a cooling system, the method comprising:
opening the injection mold;
preheating at least one of the first and second inner mold surfaces to a predetermined temperature with the mold surface pre-heating system;
partially closing the mold and injecting molten, free flowing resin into the injection mold; and
closing the mold to on-stops condition to form an injection compression molded part.

13. The method of claim 12, further comprising cooling the compression molded part with the cooling system.

14. The method of claim 13, wherein the step of cooling the compression molded part comprises supplying high pressure coolant through the injection mold.

15. The method of claim 12, wherein the step of heating at least one of the first and second inner mold surfaces comprises utilizing an induction heating coil to heat at least one of the first and second inner mold surfaces to a predetermined temperature.

16. The method of claim 15, further comprising selectively locating the induction coil into the injection mold for heating, and selectively removing the induction coil from the injection mold when at least one of the first and second inner mold surfaces reaches the predetermined temperature.

17. The method of claim 12, wherein the step of heating at least one of the first and second inner mold surfaces comprises utilizing a gas fired preheater to heat at least one of the first and second inner mold surfaces to a predetermined temperature.
